(19) United States
(12) Patent Application Publication
(10) Pub. No.: US 2014/0050331 A1
(43) Pub. Date: Feb. 20, 2014

(54) VEHICLE DATA COMMUNICATION MODULE HAVING CHARGING PORT

(71) Applicant: Vehicle System Co., Ltd., Seoul (KR)

(72) Inventor: Kyoung Soo Choi, Seoul (KR)

(73) Assignee: Vehicle System Co., Ltd., Seoul (KR)

(21) Appl. No.: 13/970,405

(22) Filed: Aug. 19, 2013

(30) Foreign Application Priority Data
Aug. 20, 2012 (KR) 10-2012-0090674

(51) Int. Cl. G06F 13/38

(52) U.S. Cl. CPC G06F 13/38
USPC 381/86

(57) ABSTRACT

The present invention relates to a vehicle data communication module. This module constitutes a vehicle data communication system together with a display main body and an audio device, and transmits data output from removable memory, connected to the module, to the main body. In detail, the vehicle data communication module is arranged to be spaced apart from the main body and is provided with a USB port formed in a portion thereof. The vehicle data communication module includes a data transmission unit designed to allow USB memory and an SD card to be detachable from the data transmission unit, and a charging unit designed to be capable of charging a mobile device. The data transmission unit and the charging unit are processed to be integrated into a single box or a single casing and are mounted in the vehicle.

### BACKGROUND OF THE INVENTION

1. Field of the Invention

The present invention relates, in general, to a vehicle data communication module and, more particularly, to a vehicle data communication module that enables the transfer of data using Universal Serial Bus (USB) memory or a Secure Digital (SD) card and the charging of various types of mobile devices.

2. Description of the Related Art

Recently, with the popularization of a large number of vehicles, there is a remarkable tendency to install various types of electric/electronic devices ins-de a vehicle in the pursuit of providing convenience. Meanwhile, with the striking development of fields of mobile devices or display devices and removable memory, there are continuous requirements for products which enable the use of devices, the output of various types of desired data, etc., even in vehicles.

FIG. 1 is a diagram illustrating a conventional vehicle data communication system. The illustrated system is a data communication system using a so-called “navigation system,” and includes a display main body 1, an audio speaker 2, and a Secure Digital (SD) card 3 as memory for providing data to the main body 1.

The SD card is one of many available portable semiconductor memory devices, and is implemented using silicon semiconductor technology to include a plurality of flash memory devices and a single microprocessor. This card is advantageous in that it has a small size and is lightweight, enables fast storage and reading, and also has a large capacity. Therefore, such an SD card has been widely used in the fields of computer peripherals, portable information terminals, digital cameras, etc.

In the above vehicle navigation system, the SD card 3 is also used, and the problem thereof is related to the arrangement of the card. As shown in the drawing, a current structure uses the SD card 3 in such a way that an exclusive port 5 is formed on the front 4 of the main body 1 around a screen, and the SD card 3 is inserted into the exclusive port 5. In this case, there is an advantage in that the SD card 3 may be detached from the port 5 and may be conveniently updated.

However, a complicated design is required in such a way that the exclusive port 5 only for the SD card 3 is installed on the front 4 of the main body 1 and a communication circuit suitable for such a design is formed. As a result, there are many limitations in the designing or the planning of the main body 1 and the front 4 thereof. Further, when the port 5 or the circuit is defective or is damaged, at least the entirety of the main body 1 must be replaced, and this causes a considerable loss from an economic aspect.

Meanwhile, recently, there are cases where a module 6 in which a USB port 7 is formed is provided in a vehicle, and is connected to the display main body 1, thus allowing a driver or a user to apply his or her portable USB memory 8 to the module 6 and listen to desired music and watch videos in the vehicle.

A USB is an interface standard for computers and peripherals thereof, and has recently been introduced to most of various types of digital electronic products, for example, a Personal Digital Assistant (PDA), a digital camera, or a digital media player, as well as a computer system such as a notebook computer. With the development of related technology, high-speed data transmission and processing are possible in USB 2.0 specification. The universalization of USB will be further accelerated with such a trend.

The present inventor investigated a possibility that the SD card 3 may be effectively mounted using the USB module 6.

Meanwhile, a large number of chargers using the power of a vehicle have been propagated. The charging of mobile phones, such as smart phones, and various types of mobile devices is mainly performed by mounting an exclusive vehicle charger on a power connection part in which the cigar lighter jack of the vehicle is mounted, thus charging mobile phones and mobile devices. In this way, the charging of mobile phones and mobile devices prevents the power of the cigar lighter jack or other devices (for example, an external navigation device or the like) from being connected during charging. Then, an economic disadvantage occurs in that an exclusive charger must be separately purchased.

In order to solve the problem of conventional charging technology, Korean Utility Model Application No. 2004-17351 (entitled “Composite device having a function of wirelessly transmitting signals output from voice call devices of various audio appliances and a USB charging function”) presents technology for charging mobile phones through a USB port.

This technology is configured such that, in order to charge mobile phones, a circuit capable of charging mobile phones through the USB port of a computer is embedded in the device, thus enabling the mobile phones to be charged through the USB port while a user is traveling or on a business trip, even if a mobile phone charger is not used. That is, this technology discloses contents of technology for installing a power control unit (designated as a “constant voltage output unit”) in the device and charging mobile phones through the USB port in the vehicle.

However, the “charging of mobile phones using the USB port” here is presented as an extremely basic configuration in which only a constant voltage output unit and a USB port are installed in the vehicle and are configured to perform charging. Accordingly, this technology may be profitable for the charging of designated devices. However, in vehicles, charging of different types of devices or high-speed charging may be required, and so it is impossible to meet such requirements.

This problem occurs because a constant voltage control function performs specific or average control rather than precise current and voltage control for different types of mobile phones. As a countermeasure, there may be a method of detaching an existing mounted device if necessary, revising a charging circuit and constant voltage control, and then re-mounting the revised circuit. However since this method requires high cost and a lot of time, it is not preferable.

Therefore, a separate method or means other than an existing configuration or method is required so as to perform smooth charging or quick charging regardless of the type of mobile devices within a vehicle.

However, as the models of smart phones are diversified, respective exclusive chargers must be used to perform quick charging. This case does not satisfy desires of various consumers, and thus the provision of charging means that can be universally used regardless of the type of smart phones is urgently required. Further, as the usage frequency of smart phones increases, the consumption of batteries frequently occurs. Therefore, the provision of charging means that can be easily used even during the driving of a vehicle is urgently required.

The present inventor has simultaneously investigated a possibility that the SD card 3 may be effectively mounted using the USB module 6 and investigated whether the function of charging various types of mobile devices may be added to such a structure, and, as a result, the present invention was completed.

### SUMMARY OF THE INVENTION

Accordingly, the present invention has been made keeping in mind the above problems occurring in the prior art, and an object of the present invention is to provide a vehicle data communication module, in which an SD port is formed using a USB module and which transmits various types of data using an SD card through the SD port, thus enabling the design and implementation of a display main body to be freely performed, and the repair and replacement of SD-related components to be conveniently performed.

Another object of the present invention is to provide a vehicle data communication module that uses a USB module so as to mount an SD card and transmits both data of the SD card and USB data to a display main body based on a common USB standard, thus enabling the design and implementation of modules and transmission lines to be simply and conveniently performed.

A further object of the present invention is to provide a vehicle data communication module in which a charging port is formed using the above USB module and which is capable of storing and updating a charging program, thus enabling various types of mobile devices, such as smart phones, to be smoothly or quickly charged regardless of the type of mobile devices.

In order to accomplish the above objects, the present invention provides a vehicle data communication module, the module constituting a vehicle data communication system together with a display main body installed in a vehicle and an audio device configured to receive a signal from the main body and output the signal as an audible sound, and transmitting data output from removable memory connected to the module to the main body. In detail, the vehicle data communication module is arranged to be spaced apart from the main body and is provided with a Universal Serial Bus (USB) port formed in a portion thereof, and the vehicle data communication module includes a data transmission unit provided with a Secure Digital (SD) port formed on a side of the USB port and designed to allow USB memory and an SD card to be detachable from the data transmission unit; and a charging unit provided with a charging port formed in a portion of the module and designed to be capable of charging a mobile device, wherein the data transmission unit and the charging unit are processed to be integrated into a single module box or a single casing and are mounted in the vehicle, with the respective ports exposed to outside of the module.

Preferably, the data transmission unit may include an input unit including the USB port and the SD port, a second interface unit for transmitting data of the SD card based on a USB standard, a USB hub for enabling data communication based on the USB standard to be performed between the individual ports and the main body, and an output port for transmitting data from the USB hub to the main body.

Preferably, the output port may be a single port based on the USB standard and may use a 4-pin type.

Preferably, the charging unit may include a charging port, to which a mobile device to be charged or a medium for providing an exclusive charging program only for a corresponding device is connected, a first interface unit for generating a signal depending on a connection to the charging port, a microcomputer for recognizing the signal as a ‘charging’ signal or a ‘download’ signal and operating such that charging power is supplied or a charging program is downloaded from the medium, and a power unit for providing charging power required to charge the device from power of the vehicle depending on an operation of the microcomputer.

Preferably, the charging port may be a USB port.

### BRIEF DESCRIPTION OF THE DRAWINGS

FIG. 1 is a diagram showing the configuration of a conventional vehicle navigation system;

FIG. 2 is a diagram showing the configuration of a vehicle data communication system to which a module according to the present invention is applied;

FIG. 3 is a diagram showing the appearance of a vehicle data communication module according to the present invention;

FIG. 4 is a block diagram showing the configuration of the vehicle data communication module according to the present invention;

FIG. 5 is a detailed block diagram showing a data transmission unit applied to FIG. 4;

FIG. 6 is a conceptual diagram showing the connection pins of input/output parts of the data transmission unit applied to FIG. 4; and

FIG. 7 is a detailed block diagram showing a charging unit applied to FIG. 4.

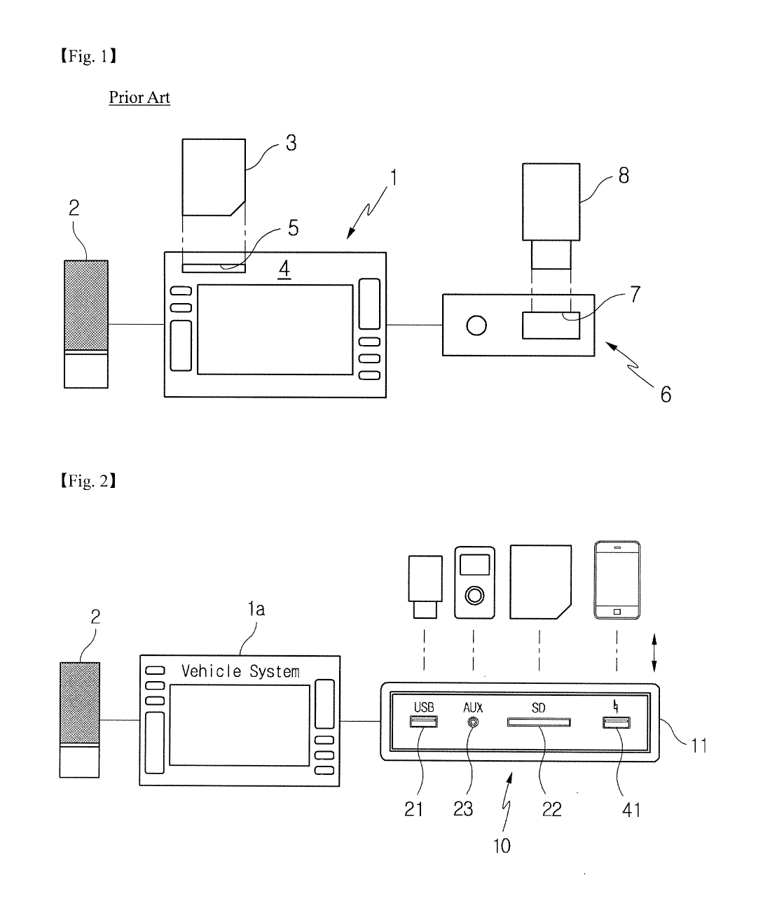

### DESCRIPTION OF THE PREFERRED EMBODIMENTS

The above and other objects, features and advantages of the present invention will be more clearly understood from the following detailed description taken in conjunction with the accompanying drawings.

Hereinafter, embodiments of the present invention will be described in detail with reference to the attached drawings.

In the drawings from FIG. 2, a vehicle data communication module according to the present invention is designated as reference numeral 10.

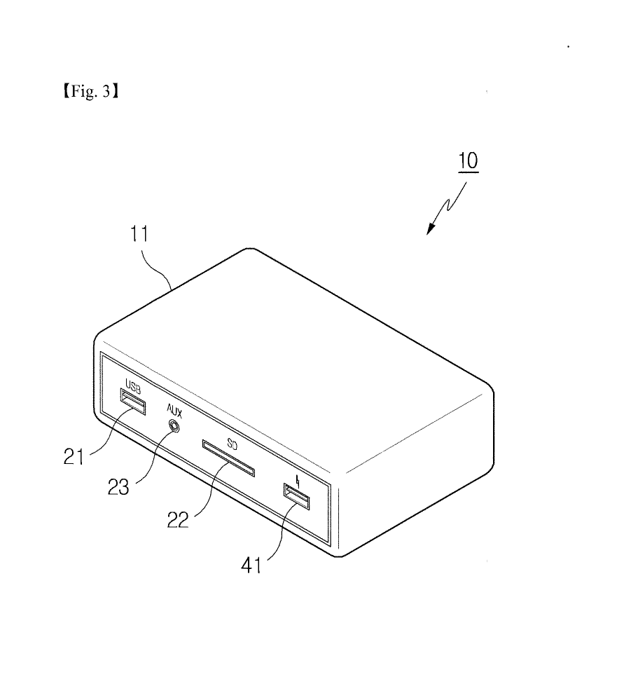

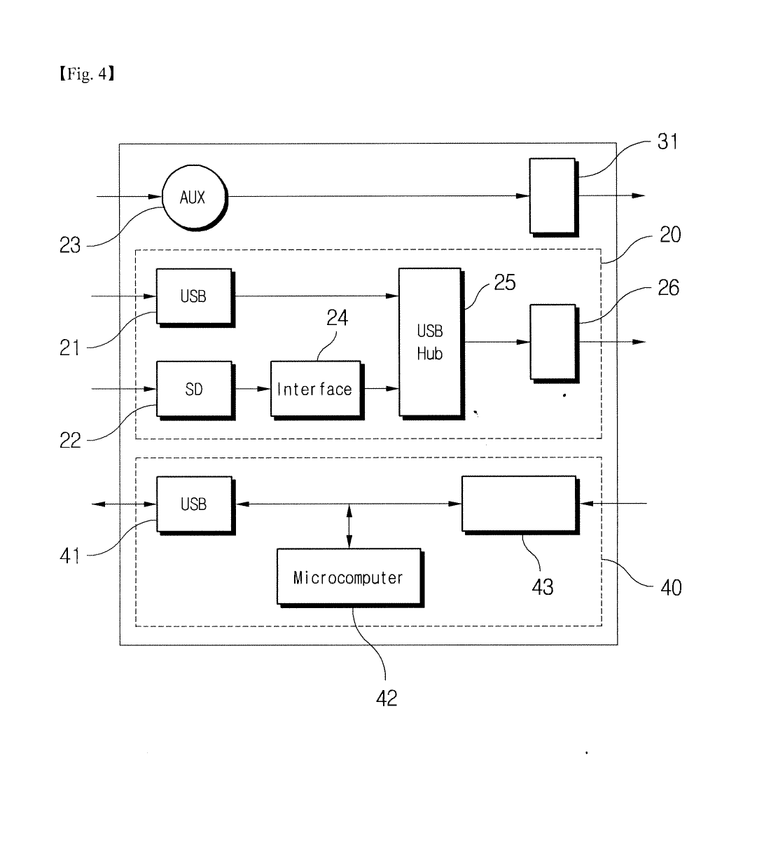

Referring to FIGS. 2 to 4, the module 10 according to the present invention configures a vehicle data communication system together with a display main body 1a installed inside a vehicle and an audio device 2 configured to receive a signal from the main body 1a and output the signal as an audible sound. From the standpoint of functionality, the module 10 performs the charging of mobile devices while transmitting data, output from removable memory connected thereto, to the main body 1a.

The module 10 of the present invention is a module arranged to be spaced apart from the display (system) main body 1a and provided with a USB port 21 formed in a portion thereof. In particular, the module 20 includes a data transmission unit 20 in which an Secure Digital (SD) port 22 is formed on one side of the USB port 21 and which is designed to allow USB memory and an SD card to be detachable from the module, and a charging unit 40 in which a charging port 41 is formed in a portion of the module and which is designed to enable the charging of mobile devices. Further, the data transmission unit 20 and the charging unit 40 are processed to be integrated into a single box or a single casing 11 and are mounted in the vehicle, with the respective ports exposed to the outside of the module 10.

The SD card is detachably mounted in the SD port 22 formed in a portion of the module 10. The module 10 is arranged to be spaced apart from the main body 1a, and it is apparent that the USB port 21 in which USB memory is to be mounted is formed in a portion of the module. Here, the USB port 21 and the SD port 22 basically constitute an input unit. However, in the present embodiment, the module 10 further includes an Auxiliary (AUX) jack 23 as an input unit.

For example, video signals received from the respective input units 21, 22, and 23 are finally output through the display main body 1a and audio signals received from the respective input units 21, 22, and 23 are finally output through the audio device 12 of the vehicle. The user of the system may watch and listen to desired video, audio, music, etc. using removable memory, that is, an SD card, USB memory, an MP3 player, etc. In particular, when the SD card stores and transmits map data, a vehicle navigation system is constructed. In this system, the SD card does not physically interfere with the main body 1a, and is attached to and detached from the main body 1a using the separate module 10.

Meanwhile, the user connects his or her mobile device to the charging port 41, thus enabling the charging of the mobile device to be performed using the power of the vehicle.

To realize a simple design, the module 10 may be individually provided with a USB standard communication circuit and an SD standard communication circuit so as to perform data communication with the main body 1a. However, in this case, there are disadvantages in that the configuration and arrangement of individual circuits and the configuration and arrangement of end output ports corresponding to the respective circuits are complicated, and economical efficiency is low in a manufacturing process. Accordingly, in the present invention, the data transmission unit 20 is designed to perform data communication with the main body 1a based on a unified USB standard. Of course, an AUX circuit is treated as a separate component.

Further, more simply, the module 10 may include a charging circuit to which only the power of the vehicle is connected so as to charge devices. However, there is a disadvantage in that when an exclusive program only for each device is required, the charging circuit cannot be used. Then, in the present invention, the charging unit 40 is designed to download a charging program if necessary.

Referring to FIG. 4, the data transmission unit 20 includes an input init including the USB port 21 and the SD port 22, an interface unit 24 for converting data of an SD card into that of a USB standard and transmitting the USB data, a USB hub 25 for enabling data communication based on the USB standard between the individual ports 21 and 22 and the main body 1a, and an output port 26 for transmitting data passing through the hub 25 to the main body 1a. That is, data of the USB memory inserted into the USB port 21 is immediately transferred to the USB hub 25, and data of the SD card inserted into the SD port 22 is transferred to the USB hub 25 after being adjusted to the USB standard through the interface unit 24.

Reference numeral 31 denotes an exclusive output port only for the AUX jack 23.

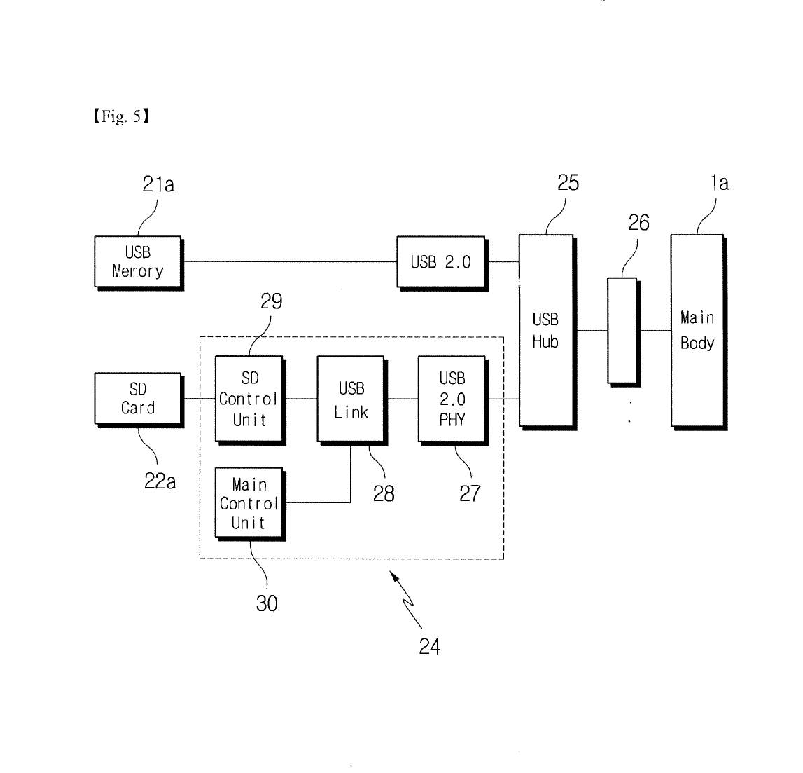

Referring to FIG. 5, the interface unit 24 of the data transmission unit 20 includes, in detail, a USB 2.0 physical layer interface (PHY) 27, a USB link 28, an SD card control unit 29, and a main control unit 30.

The USB 2.0 PHY 27 enables data transmission to be performed in accordance with a signal level between the main body 1a and the USB link 28. The USB link 28 enables data communication to be performed between the USB 2.0 PHY 27 and the SD card control unit 29 in conformity with a USB communication protocol therebetween, and such data communication is performed under the control of the main control unit 30. The SD card control unit 29 is provided subsequent to the USB link 28, and is configured to enable data communication to be performed between an SD card 22a and the main body 1a under the control of the main control unit 30.

In this case, the main control unit 30 connects the SD card to the SD card control unit 29, and enables data communication to be performed between the SD card and the main body 1a by controlling the SD card control unit 29, and also enables data communication conforming to the USB communication protocol to be performed between the USB 2.0 PHY 27 and the SD card control unit 29 by controlling the USB link 28.

Of course, data communication conforming tb the USB communication protocol is also performed between USB memory 21a and the main body 1a. Therefore, the SD card 22a and the USB memory 21a for storing data may be connected to the USB hub 25. Further, all data of the SD card and the USB memory is transmitted to the main body 1a via the single output port 26.

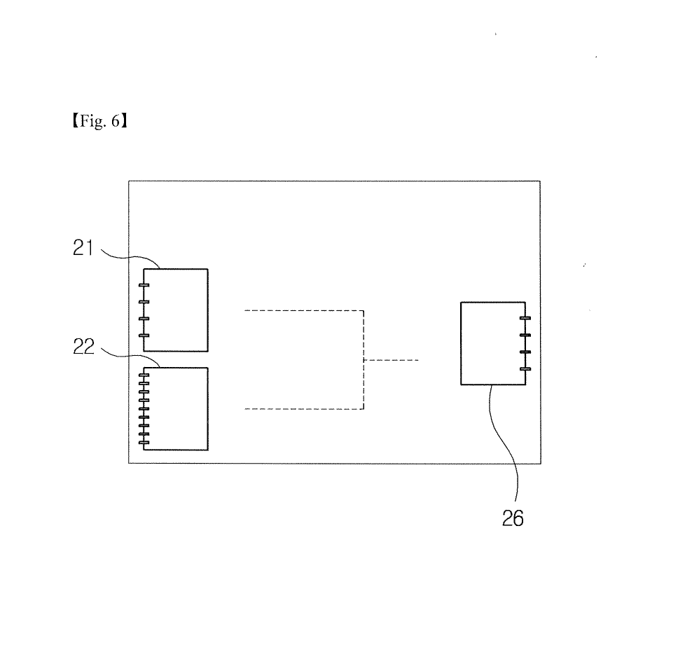

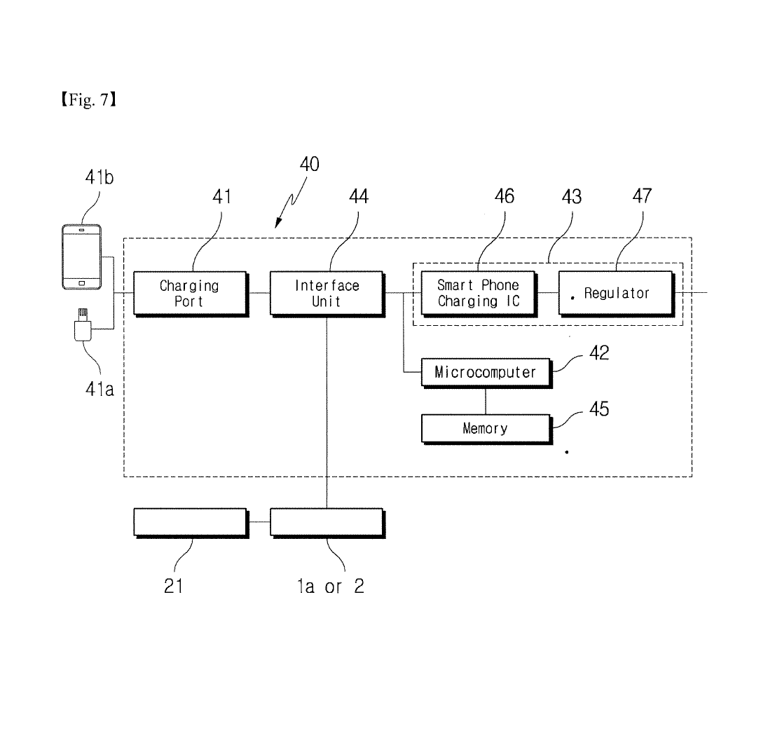

Referring to FIG. 6, the output port 26 is implemented using a 4-pin type based on the USB standard. In a typical data communication protocol, the USB standard uses a 4-pin type, and the SD standard a 9-pin type. However, in the present embodiment, SD data is transmitted in conformity with the USB standard through the interface unit 24. Therefore, at least the output port 26 may be unified and designed in a 4-pin type that is the USB standard. Accordingly, it is apparent that the design and implementation of products may be simplified.

Referring back to FIG. 4, the charging unit 40 includes a charging port 41 to which a mobile device to be charged or a medium for providing an exclusive charging program only for the corresponding device is connected, a microcomputer 42 for controlling the operation of the charging unit 40 in response to a signal generated by the connection of the charging port 41, and a power unit 43 for supplying charging power under the control of the microcomputer 42.

Referring to FIG. 7, the charging unit 40 includes, in greater detail, a charging port 41 to which a mobile device 41b to be charged or a medium 41a for providing an exclusive charging program only for the corresponding device is connected, an interface unit 44 for generating a signal depending on a connection to the charging port 41, a microcomputer 42 for recognizing the signal as a ‘charging’ or ‘download’ signal and operating to supply charging power or download a charging program from the medium, and a power unit 43 for providing charging power, required to charge the device, from the power of the vehicle, depending on the operation of the microcomputer 42.

Here, reference numeral 41b denotes a smart phone exemplified as the mobile device, and reference numeral 41a denotes USB memory exemplified as a medium for storing an exclusive charging program only for the device.

The charging port 41 denotes a USB port arranged on the front of the module 10. As described above, the smart phone 41b to be charged or the medium 41a for providing the exclusive charging program only for the corresponding smart phone 41b is selectively connected to the charging port 41. That is, in the present invention, the charging port 41 may be a data transmission port, rather than only the charging port.

In the present embodiment, the medium is removable memory for storing an exclusive charging program, in particular, USB memory. This is the most convenient medium. However, the medium of the present invention is not limited to a specific type. According to the embodiment, the storage medium 41a may be a device, such as the smart phone 41b, wherein the charging program may be either provided over the Internet accessed in a wireless manner or provided by an application.

The interface unit 44 generates a signal based on the connection of the device through a connection to the charging port 41. The generated signal is recognized and processed as a ‘charging’ signal or a ‘download’ signal by the microcomputer 42. Signal recognition methods used here may be designed in various manners in such a way as to distinguish a ‘charging’ signal from a ‘download’ signal using, for example, a method of, when data is recognized or input through the charging port 41, recognizing the corresponding signal as a download signal other than a charging signal; or a method of, when the charging circuit is not merely connected, recognizing the corresponding signal as a download signal.

Depending on the characteristics of the device connected to the charging port 41, there is a case where both a ‘charging’ signal and a ‘download’ signal are recognized. In this case, the microcomputer 42 may be operated in response to both the signals. The present invention does not exclude this case. Meanwhile, although the interface unit 44 has been shown as a separate component in the drawing, it may be functionally implemented within the microcomputer 42 as the internal circuit of the microcomputer 42.

The microcomputer 42 is operated to supply charging power or download a charging program in response to a signal from the interface unit 44. That is, when the smart phone 41b is connected to the charging port 41, the charging unit 40 is operated in a charging mode, whereas when the medium 41a is connected to the charging port 41, the charging unit 40 is operated in a download mode. In this case, ‘download’ should be understood to include all of program storage and update operations.

The microcomputer 42 includes memory 45 for storing device data about the smart phone 41b and data about the downloading of a charging program.

The power unit 43 supplies charging power required to charge the smart phone 41b from the power of the vehicle depending on the operation of the microcomputer 42. For this operation, a smart phone charging Integrated Circuit (IC) 46 is provided in the power unit 43. Generally, a voltage of 12V or 24V supplied from the battery of the vehicle is converted into power of 5V suitable for the smart phone 41b, and, for this operation, a regulator 47 is further provided in the power unit 43. When the vehicle provides its own power as a voltage of 5V, the regulator 47 is not installed.

The microcomputer 42 previously stores data about various types of smart phones 41b and programs required to perform power control based on the stored data and is implemented as a typical microcomputer so as to execute programs required to control power and process various types of signals.

As described above, the charging unit 40 is processed to be integrated into a box or the casing 11, together with other functional parts, and is mounted at a location near to the driver or an occupant of the vehicle or a location where it can be easily used. In this case, it is apparent that the individual ports 21, 22, 23, and 41 must be exposed to the outside of the module. In the present embodiment, the data transmission unit 20 including the USB port 21 and the SD port 22, and the AUX jack 23 may be present as other functional parts.

In this way, when the data communication module 10 of the present invention is arranged in the vehicle, each user determines whether his or her smart phone 41b can be charged through the charging port 41. If it is determined that the smart phone 41b cannot be charged, the user may download an exclusive charging program to the charging unit 40 through the charging port 41, and then charge the smart phone 41b. Therefore, the user may easily charge his or her smart phone 41b regardless of the type of smart phone.

Further, referring to FIG. 7, the present invention may be designed to provide a charging program even through the USB port 21 in addition to the charging port 41. For this function, the USB port 21 is connected to the interface unit 44. In this case, when the medium 41a containing the charging program is connected to the USB port 21, the interface unit 44 generates a connection signal, and the microcomputer 42 recognizes the signal as a ‘download’ signal.

By means of this method, the charging program may be downloaded from the medium. According to this configuration, even in a case where the user connects the medium containing the charging program to the USB port 21 as well as a case where the user connects the medium to the charging port 41, an advantage of enabling smooth data storage to be performed can be obtained.

In greater detail, the USB port 21 is connected to the interface unit 44 through the main body 1a or the audio device 2. In this case, when the medium 41a is connected to the port 21, the interface unit 44 generates a connection signal in such a way that the main body 1a or the audio device 2 transmits or passes a charging program other than data to be played. Then, the microcomputer 42 recognizes the connection signal as a ‘download’ signal, and enables the charging program to be downloaded from the medium.

Although the smart phone 41b has been illustrated and described as the mobile device to be charged, the function of the charging unit 40 is not limited only to that of a smart phone.

According to the vehicle data communication module of the present invention, the following advantages may be obtained.

First, an SD card is mounted on a USB module arranged to be spaced apart from a main body. Accordingly, there is an advantage in that data can be conveniently updated and, in addition, a system main body may be freely designed without being restricted by the port of an SD card. When a fault or damage affects parts related to the SD card, the repair or replacement of the parts may be easily performed.

Second, data of the SD card is transmitted based on a USB standard. That is, a USB module processes USB data and SD card data in conformity with a unified communication protocol. Therefore, there is an advantage in that the design and implementation of the module are relatively simplified.

Third, an output port is a single port based on the USB standard, and uses a 4-pin type. Therefore, there is an advantage in that the implementation of the module or the system is simplified.

Fourth, there is an advantage in that a mobile device is connected to a charging port, and charging may be easily performed within the vehicle. In particular, as the downloading of a charging program can be automatically performed, the module of the present invention may be conveniently applied to any mobile device regardless of the type of mobile device.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A vehicle data communication module, the module constituting a vehicle data communication system together with a display main body installed in a vehicl and an audio device configured to receive a signal from the main body and output the signal as an audible sound, and transmitting data output from removable memory connected to the module to the main body, wherein:
the vehicle data communication module is arranged to be spaced apart from the main body and is provided with a Universal Serial Bus (USB) port formed in a portion thereof, the vehicle data communication module comprising:
a data transmission unit provided with a Secure Digital (SD) port formed on a side of the USB port and designed to allow USB memory and an SD card to be detachable from the data transmission unit; and
a charging unit provided with a charging port formed in a portion of the module and designed to be capable of charging a mobile device,
wherein the charging unit includes a charging port, to which a mobile device to be charged or a medium for providing an exclusive charging program only for a corresponding device is connected, a first interface unit for generating a signal depending on a connection to the charging port, a microcomputer for recognizing the signal as a ‘charging’ signal or a ‘download’ signal and operating such that charging power is supplied or a charging program is downloaded from the medium, and a power unit for providing charging power required to charge the device from power of the vehicle depending on an operation of the microcomputer, and
wherein the data transmission unit and the charging unit are processed to be integrated into a single module box or a single casing and are mounted in the vehicle, with the respective ports exposed to outside of the module.

2. The vehicle data communication module of claim 1, wherein the data transmission unit comprises:
an input unit including the USB port and the SD port;
a second interface unit for transmitting data of the SD card based on a USB standard;
a USB hub for enabling data communication based on the USB standard to be performed between the individual ports and the main body; and
an output port for transmitting data from the USB hub to the main body.

3. The vehicle data communication module of claim 2, wherein the output port is a single port based on the USB standard, and uses a 4-pin type.

4. The vehicle data communication module of claim 2, wherein the second interface unit comprises:
a USB 2.0 physical layer interface (PHY) for enabling data transmission to be performed in accordance with a signal level between the main body and a USB link;
the USB link for enabling data communication to be performed between the USB 2.0 PHY and an SD card control unit in conformity with a USB communication protocol therebetween;
the SD card control unit provided subsequent to the USB link and configured to perform data communication between the SD card and the main body; and
a main control unit for controlling an overall operation of the second interface unit.

5. The vehicle data communication module of claim 1, wherein the first interface unit is functionally implemented as a circuit of the microcomputer.

6. The vehicle data communication module of claim 1, wherein the charging port is a USB port.

7. The vehicle data communication module of claim 1, wherein the microcomputer comprises memory for storing data about the mobile device or data about downloading of a charging program.

8. The vehicle data communication module of claim 1, wherein:
the USB port is connected to the first interface unit,
when the medium is connected to the USB port, the first interface unit generates a connection signal, and
the microcomputer recognizes the connection signal as a ‘download’ signal.

9. The vehicle data communication module of claim 1, wherein:
the USB port is connected to the first interface unit through the main body or the audio device,
when the medium is connected to the USB port, the first interface unit generates a connection signal as the main body or the audio device transmits or passes a charging program, and
the microcomputer recognizes the connection signal as a ‘download’ signal.
